(19) United States
(12) Patent Application Publication
(10) Pub. No.: US 2005/0220286 A1
(43) Pub. Date: Oct. 6, 2005

(54) Method and apparatus for facilitating integrated access to communications services in a communication device

(76) Inventors: John Valdez, Flower Mound, TX (US); Amit Patadia, Plano, TX (US); Vamshi Gillipalli, Irving, TX (US); Lan Pham, Irving, TX (US); Vivek Pachaiyappan, Irving, TX (US); Peter Swamidas, Orem, UT (US); John Leslie, Richardson, TX (US)

Correspondence Address: Joel Wall, Esq.;c/o Christian Andersen, Verizon Corporate Services Group Inc., 600 Hidden Ridge, HQE03H14, Irving, TX, 75038, US

(21) Appl. No.: 11/091,158

(22) Filed: Mar. 28, 2005

Related U.S. Application Data
(63) Continuation-in-part of application No. 10/083,793, filed on Feb. 27, 2002.
(63) Continuation-in-part of application No. 10/083,792, filed on Feb. 27, 2002.
(63) Continuation-in-part of application No. 10/083,884, filed on Feb. 27, 2002.
(63) Continuation-in-part of application No. 10/083,822, filed on Feb. 27, 2002.
(63) Continuation-in-part of application No. 10/720,661, filed on Nov. 24, 2003.
(63) Continuation-in-part of application No. 10/720,859, filed on Nov. 24, 2003.
(63) Continuation-in-part of application No. 10/721,009, filed on Nov. 24, 2003.
(63) Continuation-in-part of application No. 10/720,943, filed on Nov. 24, 2003.
(63) Continuation-in-part of application No. 10/721,005, filed on Nov. 24, 2003.
(63) Continuation-in-part of application No. 10/720,868, filed on Nov. 24, 2003.
(63) Continuation-in-part of application No. 10/720,970, filed on Nov. 24, 2003.
(63) Continuation-in-part of application No. 10/720,952, filed on Nov. 24, 2003.
(63) Continuation-in-part of application No. 10/720,870, filed on Nov. 24, 2003.
(63) Continuation-in-part of application No. 10/720,633, filed on Nov. 24, 2003.
(63) Continuation-in-part of application No. 10/720,971, filed on Nov. 24, 2003.
(63) Continuation-in-part of application No. 10/720,784, filed on Nov. 24, 2003.
(63) Continuation-in-part of application No. 10/720,920, filed on Nov. 24, 2003.
(63) Continuation-in-part of application No. 10/720,825, filed on Nov. 24, 2003.
(63) Continuation-in-part of application No. 10/720,944, filed on Nov. 24, 2003.
(63) Continuation-in-part of application No. 10/720,933, filed on Nov. 24, 2003.
(63) Continuation-in-part of application No. 10/720,938, filed on Nov. 24, 2003.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.
(60) Provisional application No. 60/272,122, filed on Feb. 27, 2001.
(60) Provisional application No. 60/272,167, filed on Feb. 27, 2001.
(60) Provisional application No. 60/275,667, filed on Mar. 13, 2001.
(60) Provisional application No. 60/275,719, filed on Mar. 13, 2001.
(60) Provisional application No. 60/275,020, filed on Mar. 13, 2001.
(60) Provisional application No. 60/275,031, filed on Mar. 13, 2001.
(60) Provisional application No. 60/276,505, filed on Mar. 19, 2001.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/428,704, filed on Nov. 25, 2002.
(60) Provisional application No. 60/436,018, filed on Dec. 26, 2002.
(60) Provisional application No. 60/556,462, filed on Mar. 26, 2004.

(51) Int. Cl. H04M 3/42; H04M 1/64; H04M 11/10

(52) U.S. Cl. 379/211.02; 379/88.07; 455/413

(57) ABSTRACT

A method and apparatus for facilitating integrated access to communication services in a communication device. The apparatus may include hardware components, a memory having a client application for providing a software interface with a user and an abstraction interface for interfacing the hardware components with the client application, and a processor for running the client application and the device interface, wherein the abstraction interface comprises an unmanaged layer and a managed layer.

### RELATED APPLICATIONS

This application is a continuation-in-part of U.S. patent application Ser. No. 10/083,793, entitled “METHOD AND APPARATUS FOR CALENDARED COMMUNICATIONS FLOW CONTROL,” filed Feb. 27, 2002; U.S. patent application Ser. No. 10/083,792, entitled “VOICE MAIL INTEGRATION WITH INSTANT MESSENGER,” filed Feb. 27, 2002; U.S. patent application Ser. No. 10/083,884, entitled “DEVICE INDEPENDENT CALLER ID,” filed Feb. 27, 2002; and U.S. patent application Ser. No. 10/083,822, entitled “METHOD AND APPARATUS FOR A UNIFIED COMMUNICATION MANAGEMENT VIA INSTANT MESSAGING,” filed Feb. 27, 2002, all of which claim priority to U.S. Provisional Patent Application Nos. 60/272,122, 60/272,167, 60/275,667, 60/275,719, 60/275,020, 60/275,031, and 60/276,505, and all of which are expressly incorporated herein by reference in their entirety.

This application is also a continuation-in-part of U.S. patent application Ser. No. 10/720,661, entitled “METHODS AND SYSTEMS FOR DRAG AND DROP CONFERENCE CALLING,” filed Nov. 24, 2003; U.S. patent application Ser. No. 10/720,859, entitled “METHODS AND SYSTEMS FOR CONFERENCE CALL BUFFERING,” filed Nov. 24, 2003; U.S. patent application Ser. No. 10/721,009, entitled “METHODS AND SYSTEMS FOR COMPUTER ENHANCED CONFERENCE CALLING,” filed Nov. 24, 2003; U.S. patent application Ser. No. 10/720,943, entitled “METHODS AND SYSTEMS FOR REMOTE CALL ESTABLISHMENT,” filed Nov. 24, 2003; U.S. patent application Ser. No. 10/721,005, entitled “METHODS AND SYSTEMS FOR CALL MANAGEMENT WITH USER INTERVENTION,” filed Nov. 24, 2003; U.S. patent application Ser. No. 10/720,868, entitled “METHODS AND SYSTEMS FOR DIRECTORY INFORMATION LOOKUP,” filed Nov. 24, 2003; U.S. patent application Ser. No. 10/720,970, entitled “METHODS AND SYSTEMS FOR AUTOMATIC COMMUNICATION LINE MANAGEMENT BASED ON DEVICE LOCATION,” filed Nov. 24, 2003; U.S. patent application Ser. No. 10/720,952, entitled “METHODS AND SYSTEMS FOR ADAPTIVE MESSAGE AND CALL NOTIFICATION,” filed Nov. 24, 2003; U.S. patent application Ser. No. 10/720,870, entitled “METHODS AND SYSTEMS FOR A CALL LOG,” filed Nov. 24, 2003; U.S. patent application Ser. No. 10/720,633, entitled “METHODS AND SYSTEMS FOR AUTOMATIC FORWARDING OF COMMUNICATIONS TO A PREFERRED DEVICE,” filed Nov. 24, 2003; U.S. patent application Ser. No. 10/720,971, entitled “METHODS AND SYSTEMS FOR LINE MANAGEMENT,” filed Nov. 24, 2003; U.S. patent application Ser. No. 10/720,784, entitled “METHODS AND SYSTEMS FOR CONTACT MANAGEMENT,” filed Nov. 24, 2003; U.S. patent application Ser. No. 10/720,920, entitled “METHODS AND SYSTEMS FOR NOTIFICATION OF CALL TO PHONE DEVICE,” filed Nov. 24, 2003; U.S. patent application Ser. No. 10/720,825, entitled “METHODS AND SYSTEMS FOR SINGLE NUMBER TEXT MESSAGING,” filed Nov. 24, 2003; U.S. patent application Ser. No. 10/720,944, entitled “METHODS AND SYSTEMS FOR MULTI-USER SELECTIVE NOTIFICATION,” filed Nov. 24, 2003; U.S. patent application Ser. No. 10/720,933, entitled “METHODS AND SYSTEMS FOR CPN TRIGGERED COLLABORATION,” filed Nov. 24, 2003; and U.S. patent application Ser. No. 10/720,938, entitled “METHODS AND SYSTEMS FOR PREEMPTIVE REJECTION OF CALLS,” filed Nov. 24, 2003, all of which claim priority to U.S. Provisional Patent Application Nos. 60/428,704 and 60/436,018, and all of which are expressly incorporated herein by reference in their entirety.

Applicants also claim the right to priority under 35 U.S.C. § 119(e) based on Provisional Patent Application No. 60/475,047, entitled “DC PHONE,” filed Jun. 2, 2003; and Provisional Patent Application No. 60/556,462, entitled “SYSTEMS AND METHODS FOR PROVIDING ACCESS TO INTEGRATED COMMUNICATION SERVICES,” filed Mar. 26, 2004; both of which are expressly incorporated herein by reference in their entirety.

The present application also relates to U.S. patent application Ser. No. 10/084,121, entitled “CALENDAR-BASED CALLING AGENTS,” filed Feb. 27, 2002, and U.S. patent application Ser. No. 10/858,973, entitled “METHODS AND SYSTEMS FOR INTEGRATING COMMUNICATIONS SERVICES,” filed Jun. 2, 2004, which are expressly incorporated herein by reference in their entirety.

### BACKGROUND

A wide variety of devices exist for communication between users. For example, a single user may have a home phone, work phone, and mobile phone. In addition, the user may also use devices such as PC's, PDA's, and pagers for data communications such as email and instant messaging.

Unfortunately, managing such a wide variety of communication devices can be difficult as well as cumbersome. Typically, to implement communication management, a person must individually manage each communication device separately. Thus, when the user wishes to change how communication is managed, the user may have to deal with numerous devices and, perhaps, service centers. Also, depending on where the user is, whether at home, work, or traveling, he or she may not have access to the devices that are only associated with the home or work, and as a result, he or she may miss important phone calls, emails, and other messages relating to each device.

Accordingly, there is a need for a method and system for converging data services with telephony services all in one unit so as to allow the user to have one central location where they can perform call management functions as well as performing various Internet and telephony related services.

### BRIEF DESCRIPTION OF THE DRAWINGS

FIG. 1 is a diagram of an exemplary data processing and telecommunications environment in which features and aspects consistent with the principals of the present invention may be implemented;

FIG. 2 is a diagram of an exemplary user terminal, consistent with the principals of the present invention;

FIG. 3 is a diagram of a voice network, consistent with the principles of the present invention;

FIG. 4 is a block diagram of a service center, consistent with the principles of the present invention;

FIG. 5 illustrates a logical architecture of an exemplary system, consistent with the present invention;

FIG. 6 is another diagram of an exemplary user terminal, consistent with the principals of present invention.

FIG. 7 illustrates exemplary features of a user terminal, consistent with the present invention; and

FIG. 8 illustrates software objects within a user terminal, consistent with the present invention.

### DETAILED DESCRIPTION OF PREFERRED EMBODIMENTS

Reference will now be made in detail to exemplary embodiments of the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Network Environment

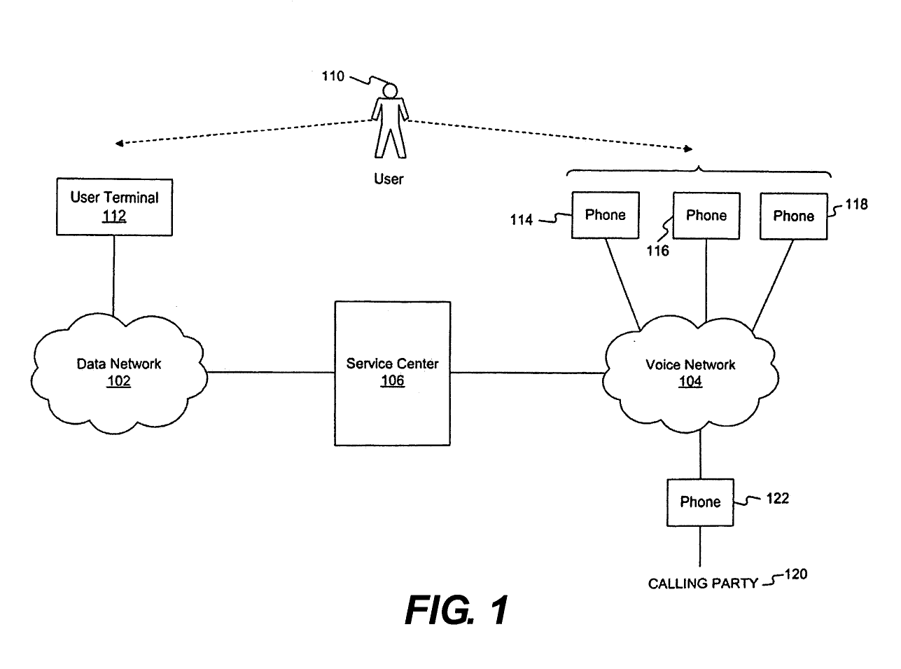

FIG. 1 is a block diagram of a data processing and telecommunications environment 100, in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Data processing and telecommunications environment 100 may include a data network 102, a voice network 104, and a service center 106. A user 110 may use a user terminal 112 to interface with data network 102 and may use phones 114, 116, and 118 to interface with voice network 104. Calling party 120 may use phone 122 to call a user, such as user 110, at any one of phones 114, 116, and 118.

Data network 102 provides communications between the various entities depicted in environment 100 of FIG. 1, such as user terminal 112 and service center 106. Data network 102 may be a shared, public, or private network and encompass a wide area or local area. Data network 102 may be implemented through any suitable combination of wired and/or wireless communication networks. By way of example, data network 102 may be implemented through a wide area network (WAN), local area network (LAN), an intranet and/or the Internet. Further, the service center 106 may be connected to multiple data networks 102, such as, for example, to a wireless carrier network and to the Internet.

Voice network 104 may provide telephony services to allow a calling party, such as calling party 120, to place a telephone call to user 110. In one embodiment, voice network 104 may be implemented using a network, such as the Public Switched Telephone Network (“PSTN”). Alternatively, voice network 104 may be implemented on a voice over broadband network, such as a network using voice-over Internet Protocol (“VoIP”) technology. Additionally, in other embodiments, the voice network may be a video over broadband network, such as, for example, a network for providing 2-way video communications. In another example, the voice network may be a wireless broadband network, such as, for example, a network using WiFi (i.e., IEEE 802.11(b) and/or (g)). In yet another example, the voice network 104 may be a wireless voice network(s), such as, for example, a cellular or third-generation cellular network). In addition, voice network 104 may be implemented using any single or combination of the above-described technologies consistent with the principles of the present invention. Further, service center 106 may be connected to multiple voice networks 104, such as for example, Verizon's™ Voice Network, voice networks operated by other carriers, and wireless carrier networks.

Service center 106 provides a platform for managing communications over data network 102 and voice network 104. Service center 106 also provides gateway functions, such as code and protocol conversions, to transfer communications between data network 102 and voice network 104. Service center 106 may be implemented using a combination of hardware, software, and/or firmware. For example, service center 106 may be implemented using a plurality of general purpose computers or servers coupled by a network (not shown). Although service center 106 is shown with direct connections to data network 102 and voice network 104, any number and type of network elements may be interposed between service center 106, data network 102, and voice network 104.

User terminal 112 provides user 110 an interface to data network 102. For example, user terminal 112 may be implemented using any device capable of accessing the Internet, such as a general purpose computer or personal computer equipped with a modem. User terminal 112 may also be implemented in other devices, such as the Blackberry™, and Ergo Audrey™. Furthermore, user terminal 112 may be implemented in wireless devices, such as pagers, mobile phones (with data access functions), and Personal Digital Assistants (“PDA”) with network connections. In one embodiment, a user terminal 112 may be implemented using a device with connections to both data network 102 and voice network 104. User terminal 112 also allows user 110 to communicate with service center 106. For example, user 110 may use instant messaging (“IM”) to communicate with service center 106. In addition, user terminal 112 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Furthermore, user terminal 112 may communicate directly with service center 106. For example, a client application may be installed on user terminal 112, which directly communicates with service center 106. Also, user terminal 112 may communicate with service center 106 via a proxy.

Phones 114, 116, 118, and 122 interface with voice network 104. Phones 114, 116, 118, and 122 may be implemented using known devices, including wireline phones and mobile phones. Although phones 114, 116, 118, and 122 are shown directly connected to voice network 104, any number of intervening elements, such as a private branch exchange (“PBX”), may be interposed between phones 114, 116, 118, and 122 and voice network 104.

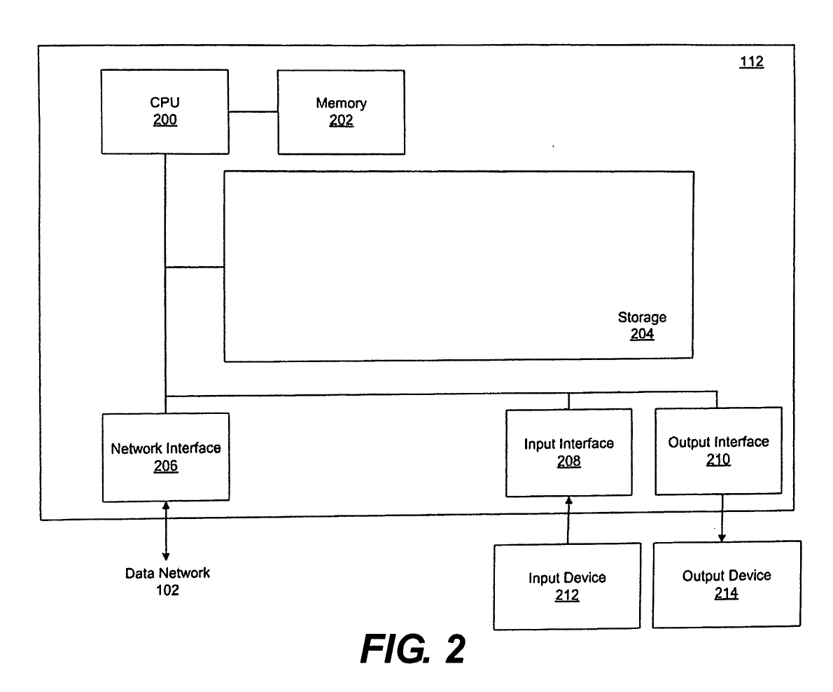

FIG. 2 is a block diagram of a user terminal consistent with the present invention. User terminal 112 may include a central processing unit (CPU) 200, a memory 202, a storage module 204, a network interface 206, an input interface 208, an output interface 210, an input device 216, and an output device 218.

CPU 200 provides control and processing functions for user terminal 112. Although FIG. 2 illustrates a single CPU, user terminal 112 may include multiple CPUs. CPU 200 may also include, for example, one or more of the following: a co-processor, memory, registers, and other processing devices and systems as appropriate. CPU 200 may be implemented, for example, using a Pentium™ processor provided from Intel Corporation.

Memory 202 provides a primary memory for CPU 200, such as for program code. Memory 202 may be embodied with a variety of components of subsystems, including a random access memory (“RAM”) and a read-only memory (“ROM”). When user terminal 112 executes an application installed in storage module 204, CPU 200 may download at least a portion of the program code from storage module 204 into memory 202. As CPU 200 executes the program code, CPU 200 may also retrieve additional portions of program code from storage module 204.

Storage module 204 may provide mass storage for user terminal 112. Storage module 204 may be implemented with a variety of components or subsystems including, for example, a hard drive, an optical drive, CD ROM drive, DVD drive, a general-purpose storage device, a removable storage device, and/or other devices capable of storing information. Further, although storage module 204 is shown within user terminal 112, storage module 204 may be implemented external to user terminal 112.

Storage module 204 includes program code and information for user terminal 112 to communicate with service center 106. Storage module 204 may include, for example, program code for a calendar application, such as GroupWise provided by Novell Corporation or Outlook provided by Microsoft Corporation; a client application, such as a Microsoft Network Messenger Service (MSNMS) client or America Online Instant Messenger (AIM) client; and an Operating System (OS), such as the Windows Operation System provided by Microsoft Corporation. In addition, storage module 204 may include other program code and information, such as program code for TCP/IP communications; kernel and device drivers; configuration information, such as a Dynamic Host Configuration Protocol (DHCP) configuration; a web browser, such as Internet Explorer provided by Microsoft Corporation, or Netscape Communicator provided by Netscape Corporation; and any other software that may be installed on user terminal 112.

Network interface 206 provides a communications interface between user terminal 112 and data network 102. Network interface 206 may receive and transmit communications for user terminal 112. For example, network interface 206 may be a modem, or a local area network (“LAN”) port.

Input interface 208 receives input from user 110 via input device 212 and provides the input to CPU 200. Input device 212 may include, for example, a keyboard, a microphone, graphical user interface, and/or a mouse. Other types of input devices may also be implemented consistent with the principles of the present invention.

Output interface 210 provides information to user 110 via output device 214. Output device 214 may include, for example, a display, (including a touchscreen or pen-based LCD display, or other type of display), a printer, and/or a speaker. Other types of output devices may also be implemented consistent with the principles of the present invention.

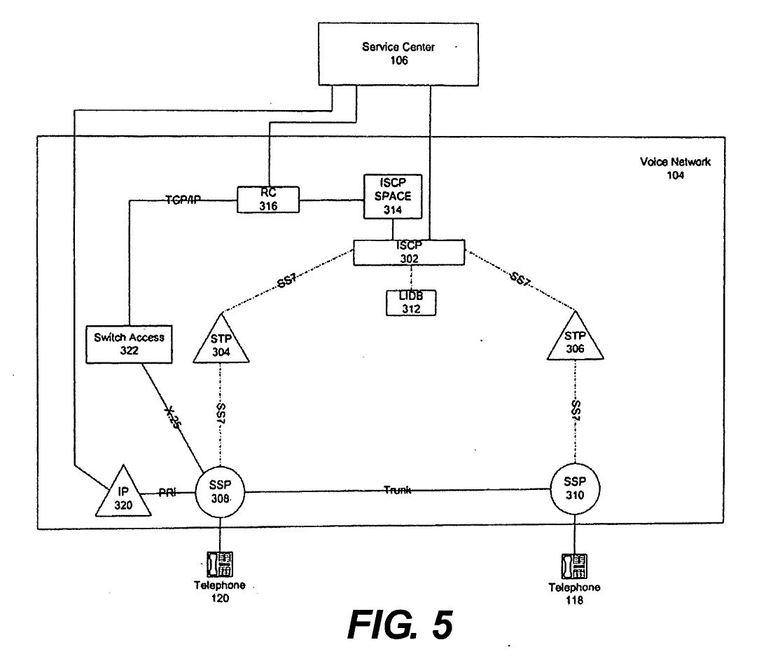

FIG. 5 is a diagram of a voice network, consistent with the principles of the present invention. As shown, voice network 104 includes an intelligent service control point (ISCP) 302, service transfer points (STP) 304 and 306, service switching points (SSP) 308 and 310, a line information database (LIDB) 312, an ISCP Service Provisioning And Creation Environment (SPACE) 314, a Recent Change Environment 316, an Intelligent Peripheral (IP) 320, and a switch access 322. Although this embodiment of a voice network 104 is described as a PSTN, as discussed above in other embodiments, the voice network 104 may be, for example, a voice or video over broadband network, a wireless broadband, a wireless voice network, etc.

Voice network 104 may be implemented using the PSTN and SS7 as a signaling protocol. The SS7 protocol allows voice network 104 to provide features, such as call forwarding, caller-ID, three-way calling, wireless services such as roaming and mobile subscriber authentication, local number portability, and toll-free/toll services. The SS7 protocol provides various types of messages to support the features of voice network 104. For example, these SS7 messages may include Transaction Capabilities Applications Part (“TCAP”) messages to support event “triggers,” and queries and responses between ISCP 302 and SSPs 308 and 310.

ISCP 302 may also be, for example, a standard service control point (SCP), an Advanced Intelligent Network (AIN) SCP, a soft switch, or any other network call controller. ISCP 302 provides translation and routing services of SS7 messages to support the features of voice network 104, such as call forwarding. In addition, ISCP 302 may exchange information with the service center 106 using TCP/IP or SS7. ISCP 302 may include service logic used to provide a switch, such as SSP 308 or 310, with specific call processing instructions. ISCP 302 may also store data related to various features that a user may activate. Such features may include, for example, call intercept and voice mail. ISCP 302 may be implemented using a combination of known hardware and software. ISCP 302 is shown with a direct connection to service center 106 and a connection to ISCP SPACE 314, however, any number of network elements including routers, switches, hubs, etc., may be used to connect ISCP 302, ISCP SPACE 314, and service center 106. Further, information exchanged between the ISCP 302 and service center 106 may use, for example, the SR-3389 General Data Interface (GDI) for TCP/IP.

STPs 304 and 306 relay SS7 messages within voice network 104. For example, STP 304 may route SS7 messages between SSPs 308 and 310. STP 304 or 306 may be implemented using known hardware and software from manufacturers such as NORTEL™ and LUCENT Technologies™.

SSPs 308 and 310 provide an interface between voice network 104 and phones 114 and 120, respectively, to setup, manage, and release telephone calls within voice network 104. SSPs 308 and 310 may be implemented as a voice switch, an SS7 switch, or a computer connected to a switch. SSPs 308 and 310 exchange SS7 signal units to support a telephone call between calling party 120 and user 110. For example, SSPs 308 and 310 may exchange SS7 messages, such as TCAP messages, within message signal units (“MSU”) to control calls, perform database queries to configuration database 312, and provide maintenance information.

Line Information Database (LIDB) 312 comprises one or more known databases to support the features of voice network 104. For example, LIDB 312 may include subscriber information, such as a service profile, name and address, and credit card validation information. Although, in this figure, LIDB 312 is illustrated as directly connected to ISCP 302, LIDB 312 may be connected to ISCP 302 through an STP (e.g., 304 and 306). Additionally, this communication link may use, for example, the GR-2838 General Dynamic Interface (GDI) for SS7.

ISCP Service Provisioning and Creation Environment (SPACE) 314 may be included as part of the ISCP 302 or be separate from the ISCP 302. For example, the Telcordia™ ISCP may include an environment similar to SPACE 314 as part of the product. Further, ISCP SPACE 314 may include one or more servers. ISCP SPACE 314 is the point in the ISCP platform where customer record updates may be made.

In one embodiment, customer records may be stored in the ISCP SPACE 314 such that the records may be updated and sent to the ISCP 302. These records may include information regarding how to handle calls directed to the customer. For example, these customer records may include information regarding whether or not calls for the customer are to be forwarded to a different number, and/or whether or not the call should be directed to an IP, such as a voice mail system, after a certain number of rings. Additionally, one ISCP SPACE 314 may provide updates to one or more ISCPs 302 via an ISCP network (not shown).

Additionally, the voice network 104 may include one or more recent change engines 316 such as, for example, an Enterprise Recent Change engine (eRC); an Assignment, Activation, and Inventory System (MIS); or a multi-services platform (MSP). As an example, the eRC and MIS may be used in voice networks 104 located in the western part of the United States, while an MSP may be used in networks in the eastern part. The recent change engines may be used to update switch and ISCP databases. For example, a recent change engine may deliver database updates to SSPs and to ISCPs, such that when updating databases, these recent change engines emulate human operators. Additionally, if the instructions are to be sent to an ISCP 302, the recent change engine may first send the instructions to the ISCP SPACE 314, which then propagates the instructions to the ISCP 302 as discussed above. Further, an MSP or eRC may be used, for example, for providing updates to both the SSPs 308 or 310 and the ISCPs 302. Or, for example, an eRC may be used for providing updates to the SSPs 308 or 310, while an MIS is used for providing updates to the ISCPs 302.

Updates sent to the SSPs 308 or 310 may be sent from the recent change engine 316 via a switch access 322 that may, for example, convert the updates into the appropriate protocol for the SSP 308 or 310. For example, recent change engine 316 may send updates to the SSPs 308 or 310 via TCP/IP. The switch access 322 may then convert the updates from TCP/IP to X.25. This switch access 322 may be implemented using hardware and/or software. These connections may include any number of elements, such as, for example, switches, routers, hubs, etc. and may be, for example, an internal data network for the voice network 104.

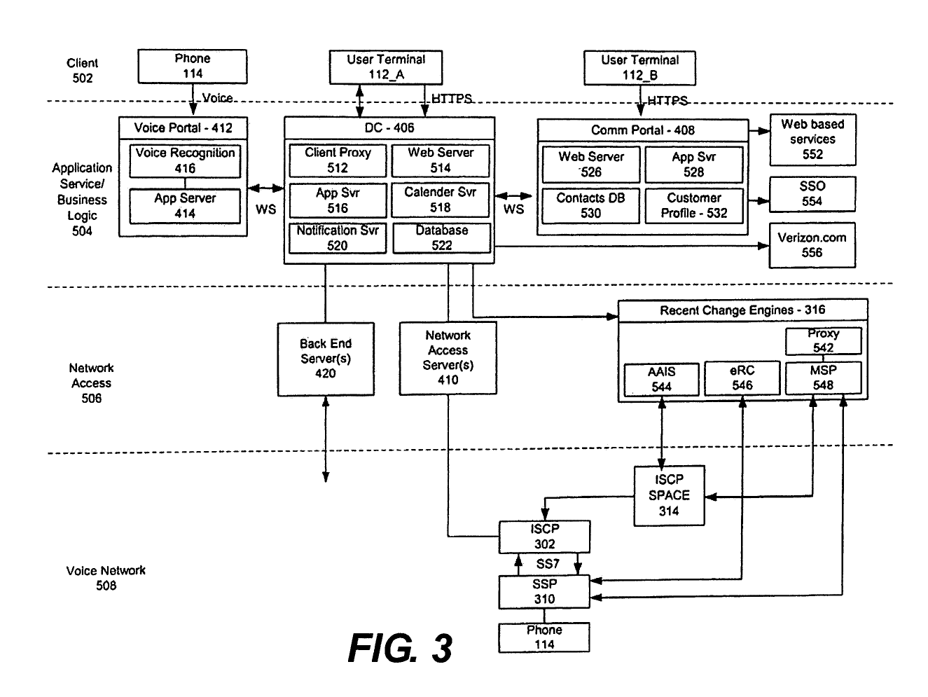

The voice network 104 may also include one or more intelligent peripherals (IP). For example, in FIG. 3, an IP 320 is illustrated as being connected to SSP 308. These IPs may be used for providing functions for interaction between users and the voice network, such as voice mail services, digit collection, customized announcements, voice recognition, etc. Moreover, the communications between the SSP 308 and IP 320 may use the Primary Rate interface (PRi) (e.g., the 1129 protocol) protocol. Additionally, the IP 320 may be capable of sending and receiving information to/from the Service Center 106. These communications may use, for example, the SR-3511 protocol. Further, although FIG. 3 illustrates this connection as a direct connection, this connection may include any number of elements including routers, switches, hubs, etc., and may be via, for example, an internal data network for the voice network 104.

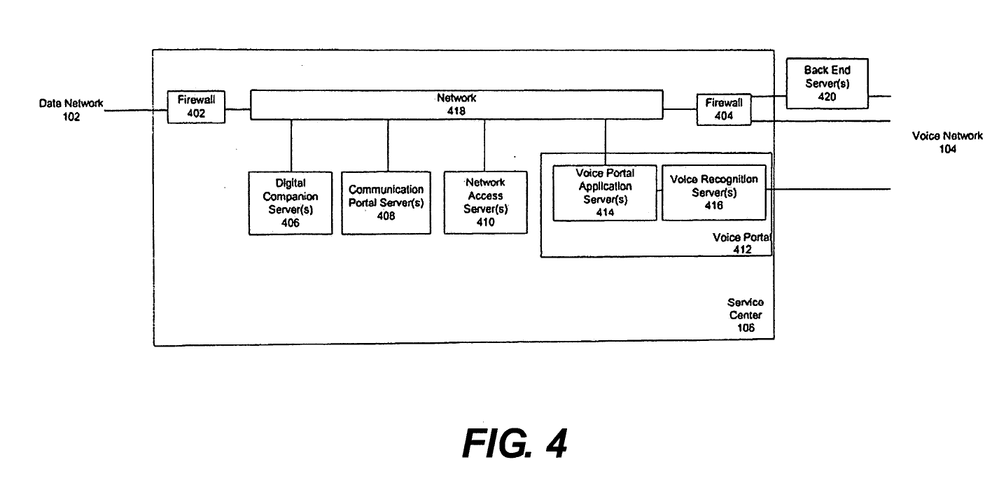

FIG. 4 is a block diagram of a service center, consistent with the principles of the present invention. As shown, service center 106 may include firewalls 402 and 404, one or more digital companion servers 406, one or more communication portal servers 408, one or more network access servers 410, and a voice portal 412. The voice portal 412 may include a voice portal application server 414 and a voice recognition server 416. A network 418 may be used to interconnect the firewalls and servers. Additionally, back end server(s) 420 may be provided between the service center 106 and the voice network 104.

Firewalls 402 and 404 provide security services for communications between service center 106, data network 102, and voice network 104, respectively. For example, firewalls 402 and 404 may restrict communications between user terminal 112 and one or more servers within service center 106. Any appropriate security policy may be implemented in firewalls 402 and 404 consistent with the principles of the present invention. Firewalls 402 and 404 may be implemented using a combination of known hardware and software, such as the Raptor Firewall provided by the Axent Corporation. Further, firewalls 402 and 404 may be implemented as separate machines within service center 106, or implemented on one or more machines external to service center 106.

Network 418 may be any type of network, such as an Ethernet or FDDI network. Additionally, network 418 may also include switches and routers as appropriate without departing from the scope of the invention. Further, additional firewalls may be present in the network 418, for example, to place one or more of servers 406, 408, 410, or voice portal 412 behind additional firewalls.

Each server (406, 408, 410, 414, 416, 420) may be any appropriate type of server or computer, such as a Unix or DOS-based server or computer. The servers may implement various logical functions, such as those described below. In FIG. 4, a different server is illustrated as being used for each logical function. In other embodiments, the logical functions may be split across multiple servers, multiple servers may be used to implement a single function, all functions may be performed by a single server, etc.

In general, a digital companion server 406 may provide the software and hardware for providing specific services of the service center. Exemplary services include, for example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, real-time call management, etc. In one embodiment, real-time call management enables a user to perform several functions as a call is being received, such as sending a call to voice mail, sending a call received on one device to another device, manually initiating protection from telemarketers, playing an announcement for the caller, scheduling a call back, bridging a caller onto a current call, etc.

A communication portal server 408 may provide the hardware and software for managing a customer's account and interfacing with customer account information stored by the provider of customer's voice network 104. The network access servers 410 may provide the hardware and software for sending and receiving information to the voice network 104 in processing the applications provided by the service center. For example, the network access servers 410 may be used for transmitting and/or receiving information from/to an ISCP 302 or an SSP 308 or 310 of the voice network 104.

The voice portal 412 includes software and hardware for receiving and processing instructions from a customer via voice. For example, a customer may dial a specific number for the voice portal 412. Then the customer using speech may instruct the service center 105 to modify the services to which the customer subscribes. The voice portal 412 may include, for example, a voice recognition function 416 and an application function 414. The voice recognition function 416 may receive and interpret dictation, or recognize spoken commands. The application function 414 may take, for example, the output from the voice recognition function 416, convert it to a format suitable for the service center 106 and forward the information to one or more servers (406, 408, 410) in the service center 106.

FIG. 3 illustrates a logical architecture of an exemplary system, consistent with the present invention. As illustrated, the logical architecture may be split into four planes: client side 502, application service 504, network access 506, and the voice network 508.

Client side 502 includes user terminals 112_A and 112_B that a user may use to send and/or receive information to/from the service center 106. Additionally, client side 502 includes the user's phone(s) 114. As discussed above, user terminals 112 may be any type of device a user may use for communicating with Service Center 106. For example, user terminal 112_A may be a PDA running a program for communicating with the Service Center 106, while user terminal 112_B may be a desktop type computer running a web browser for communicating with the Service Center 106 via the Internet. Additionally, the user may have one or more phones 114, such as, for example, one or more standard landline telephones and/or wireless phones.

The application service plane 504 includes the digital companion server(s) 406, communication portal server(s) 408, and the voice portal 412. These entities may communicate between one another using, for example, web services or any other suitable protocols. Web services are a standardized way of integrating Web-based applications using the Extensible Markup Language (XML), Simple Object Access Protocol (SOAP), Web Services Description Language (WSDL) and Universal Description, Discovery and Integration (UDDI) open standards over an Internet protocol (IP) backbone.

As illustrated, a digital companion server 406 may provide the following functions: a client proxy 512, a web server 514, an application server function 516, a calendar server function 518, a notification server function 520, and a database function 522. Each of these functions may be performed in hardware, software, and/or firmware. Further, these functions may each be executed by a separate server, split across multiple servers, included on the same server functions, or any other manner.

The client proxy function 512 provides a proxy function for the digital companion that may be used for security purposes. This client proxy function 512 may be included in a separate server such that all communications sent from the other digital companion functions/servers to a user terminal 112 via the data network 102 go through the client proxy 512. Also, if the client proxy 512 is included on a separate server, for example, an additional firewall may be provided between the client proxy 512 and the other digital companion servers to provide additional security.

Web server 514 provides functionality for receiving traffic over the data network 102 from a customer. For example, web server 514 may be a standard web server that a customer may access using a web browser program, such as Internet Explorer or Netscape Communicator.

Application server function 516 encompasses the general functions performed by the digital companion server(s) 406. For example, these functions may include interfacing with the various other digital companion functions to perform specific services provided by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

Additionally, the application server function 516 may interface with one or more external devices, such as an external web server, for retrieving or sending information. For example, the application server function 516 may interface with a voice network's data center 556 (e.g., verizon.com) to determine the services to which the customer subscribes (e.g., call waiting, call forwarding, voice mail, etc.).

Calendar server function 518 may provide the capability of scheduling events, logging when certain events occurred, triggering the application-functions to perform a function at a particular time, etc.

Notification server function 520 provides the capability to send information from the service center 106 to a user terminal 112. For example, the notification server function 520 at the direction of the application server function 516 may send a notification to the user terminal 112 that the user is presently receiving a phone call at the user's phone 114. This notification may be, for example, an instant message pop-up window that provides an identification of the caller as well as the number being called. The notification may also have a number of user-selectable buttons or items associated with it that enable the user to manage a call in real-time.

Database function 522 provides the storage of information useable by the various applications executed by the digital companion servers. These databases may be included in, for example, one or more external storage devices connected to the digital companion servers. Alternatively, the databases may be included in storage devices within the digital companion servers themselves. The storage devices providing the database function 522 may be any type of storage device, such as for example, CD-ROMs, DVD's, disk drives, magnetic tape, etc.

As discussed above, the communication portal server(s) 408 provide the hardware and software for managing a customer's account and interfacing with customer account information stored by the provider of customer's voice network 104. As illustrated in FIG. 3, a communication portal server 408 may provide the following functions: a web server function 526, an application server function 528, a contacts database function 530, and/or a customer profile function 532. Each of these functions may be performed by a separate server, split across multiple servers, included on the same server functions, or any other manner.

Web server function 526, as with web server function 514 of the digital companion servers, provides functionality for receiving traffic over the data network 102 from a customer. For example, the web server may be a standard web server that a customer may access using a web browser, such as Internet Explorer or Netscape Communicator.

The application server function 528 encompasses the general functions performed by the communication portal servers 408. For example, these functions may include interfacing with the voice network to retrieve and/or modify customer profile information, and creating and editing an address book for the user. Additionally, the application server function 528 may include the functionality of sending and/or receiving information to/from external servers and/or devices. For example, the communication portal servers 408 may be connected to a network, such as, the Internet. The application server function 528 may then provide connectivity over the Internet to external servers 552 that provide web services, such as the Superpages web page. The application server function 528 could then contact these external services 552 to retrieve information, such as an address for a person in the user's address book.

In another example, the application server function 528 of the communication portal 408 may interface a single sign on (SSO) server 554. SSO 554 may be used to allow users to access all services to which the user subscribes, on the basis of a single authentication that is performed when they initially access the network.

Moreover, the application server function 528, similar to application server 516, may provide functionality to facilitate services performed by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

The contacts database 530 includes storage devices for storing an address book for the user. This address book may be any appropriate type of address book. For example, the user's address book may include the names, phone numbers, and addresses of people and/or organizations. These storage devices may be internal or external to the communication portal servers 406 or some combination in between. In addition, these storage devices may be any type of storage device, such as magnetic storage, memory storage, etc.

The customer profile database 532 includes storage devices for storing customer profile information for the user. These storage devices may be the same or separate storage devices used for the contacts database. The customer profile may include information regarding the user's account for their voice network. For example, this information may include the user's name, billing address, and other account information. Additionally, the customer profile may include information regarding voice services to which the user subscribes, such as, for example, call waiting, voice mail, etc.

The application services plane 504 of the architecture may also include a voice portal 412. As discussed above, the voice portal 412 may include, for example, a voice recognition function 416 and an application server function 414, and be used for receiving and processing instructions from a customer via voice. The voice recognition function may be implemented using hardware and/or software capable of providing voice recognition capabilities. This hardware and/or software may be a commercially available product, such as the Voice Application platform available from Tellme Networks, Incorporated. The application server function 414 of the voice portal 412 may include hardware and/or software for exchanging information between the digital companion servers 406 and the voice recognition function 416. Additionally, the application server function 414 may be included on a separate server, included in the hardware and software providing the voice recognition function 416, included in the digital companion servers 406, etc.

The Network Access plane 506 of the architecture includes the functions for providing connectivity between the application service plane 502 and the voice network 104. For example, this plane may include the recent change engines 316, network access servers 410, and/or back end servers 420.

As discussed above, recent change engines 316 may be used to update switches and ISCP databases included in the voice network 104. In one embodiment, the recent change engines 316 may include an MIS 544, an eRC 546, and/or an MSP 548. Additionally, a proxy 542 may be used between the digital companion servers 406 and the recent change engines 542 for security purposes.

The network access servers 410 may be included in the service center 106 and may provide the hardware and software for sending and receiving information to the voice network 410 in processing the applications provided by the service center. For example, the network access servers 410 may include a Caller ID (CID) functionality for retrieving caller ID information from the voice network 104, a click to dial (CTD) functionality for instructing an intelligent peripheral (IP) in the voice network to place a call via an SSP, and/or a real time call management (RTCM) functionality for interfacing with an ISCP of the voice network.

Network Access plane 506 may also include one or more back end server(s) 420. These back end server(s) 420 may include hardware and/or software for interfacing the service center 106 and the voice network 104. The back end server(s) 420 may be connected to the service center 106 by a network, by a direct connection, or in any other suitable manner. Further, the back end server(s) 420 may connect to one or more devices in the voice network 104 by a network, a direct connection, or in any other suitable manner.

The back end server(s) 420 may include, for example, a server providing a voice mail retrieval and notification function. This voice mail retrieval and notification function may include the capability to receive notifications when a user receives a voice mail, physically call a user's voice mail system, enter the appropriate codes to retrieve the voice mail, retrieve the voice mail, convert the voice mail to a digital file, and send it to the digital companion servers 406.

Additionally, these back end server(s) 420 may also include, for example, a directory assistance server. This directory assistance server may interface the service center 106 with a Reverse Directory Assistance Gateway (RDA Gateway) of the voice network 104. An RDA Gateway is a device for issuing requests to a Data Operations Center (DOC) of the voice network 104 for name and/or address information associated with a phone number and receiving the name and/or phone number in response to this request.

In another example, the back end server(s) 420 may include a wireless internet gateway that is used for interfacing with a mobile switching center (MSC) of a wireless voice network. As with the above-described back end server(s) 420, this wireless internet gateway may be used for converting requests and information between the formats used by the service center 106 and those used by the wireless voice network.

In yet another example, the back end server(s) 420 may include a conference blasting server for instructing a conference bridge in the voice network 106 to dial out via an SSP to the participants of a voice conference. Alternatively, for example, the back end server(s) may include a server for instructing an IP of the voice network to place a call between two parties by dialing out to each of the parties. The back end server(s) may also include the capability to instruct the bridge or IP device to call an audio digitizing device that can listen to the conference, convert the audio signals to digital format, and forward the digitized signals to a user device via, for example, an audio streaming server. The audio streaming server may, for example, allow a user to connect to it via, for example, the Internet. Additionally, the audio streaming device may buffer or record the signals to permit the user to pause, rewind, and/or fast-forward thru the conference.

In yet another example, the back end server(s) 420 may include a Single Number Short Message Service (SN SMS) server for interfacing the service center 106 with a Short Message Service (SMS) gateway in the voice network 104. This may be used to permit the customer to have SMS messages addressed to their home phone number directed to an SMS capable device of the users choosing.

The voice network plane 508 includes the hardware and software included in the voice network 104, as discussed above with reference to FIG. 3. For example, the voice network plane 508 may include the ISCP SPACE 314, the ISCP 302, the intelligent peripherals 320, and the SSP 308. Additionally, the voice network plane 508 may also include the hardware and software included in a wireless carrier's network, such as, for example, the mobile switching center, etc.

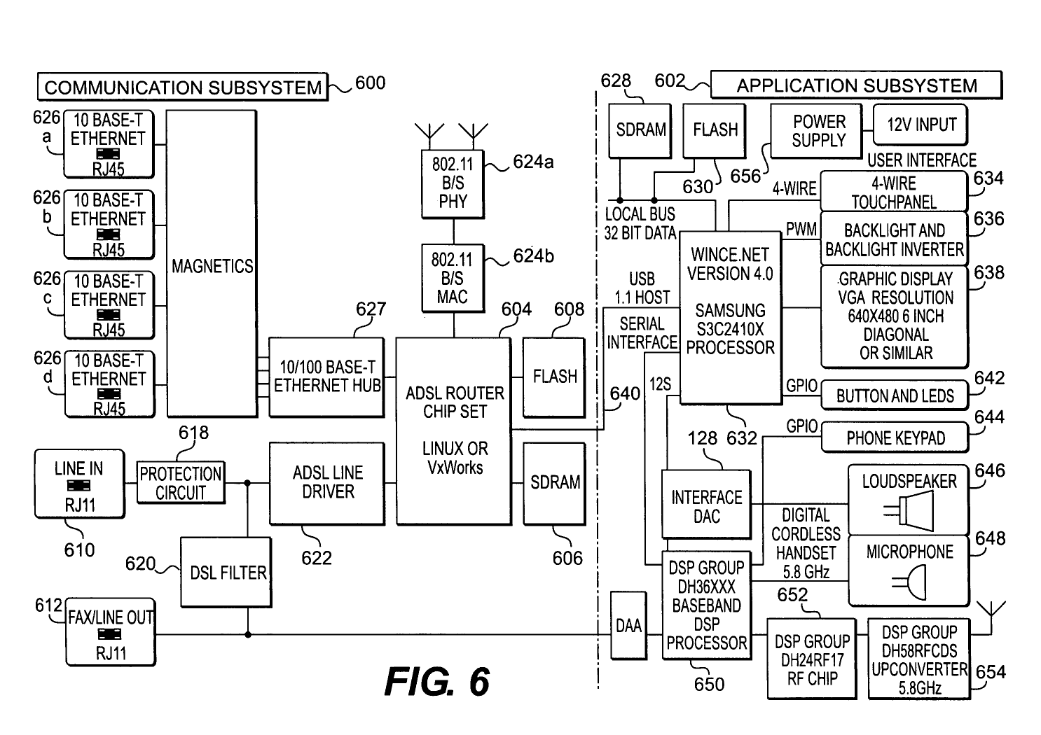

FIG. 6 illustrates another exemplary user terminal 112 consistent with the present invention. User terminal 112 of FIG. 6, for example, may be a device capable of connecting to both a data network and a voice network. User terminal 112 may include a communications subsystem 600 and an application subsystem 602. Communications subsystem 600 may be used for running the Asymmetric Digital Subscriber Line (ADSL) modem, router/switch/Ethernet, and wireless capabilities of the user terminal 112, and application subsystem 602 may be used for running applications for controlling the user interface including the LCD screen and translating user input into the appropriate software commands to allow control of user terminal 112. Communication subsystem 600 may include an ADSL Bridge Router 604 with an embedded 802.11b/g access point. Communication subsystem 600 may also include SDRAM 606 that may provide storage for program data and application data. Communication subsystem 600 may also include Flash memory 608 for storage of boot firmware, operating system, drivers, protocol stack and application programs. Moreover, communication subsystem 600 may include two RJ11 jacks. Jack (Line in) 610 may connect to a telephone outlet, while jack (Fax/Modem) 612 may provide a filtered pass-thru for a fax/modem connection. Additionally, communication subsystem 600 may include a line protection circuit 618 and a Digital Subscriber Line (DSL) filter 620 that separates the analog signal from the discrete Multitone (DMT) signal for the ADSL modem. Communication subsystem 600 may also include an ADSL line driver 622, an 802.11b/g access point 624a for the enhanced unit and a 802.11b/g station 624b for the companion unit. Communication subsystem 600 may also include a four port Ethernet switch 626a, 626b, 626c, and 626d, and a 10/100 Ethernet hub 627.

Application subsystem 602 may include SDRAM 628 that may provide storage for program data and application data. Application subsystem 602 may also include Flash memory 630 for storage of boot firmware, operating systems, drivers, protocol stack and application programs. Application subsystem 602 may also include a processor 632 and a touch panel 634, a backlight and backlight inverter 636, and a graphic display 638. A real time clock (not pictured) may also be built into the system CPU to provide the system with real time information. Application subsystem 602 communicates with the communications subsystem 600 via the Universal Serial Bus (USB) Host Rev 1.1 interface 640. Application subsystem 602 may also include pushbuttons, switches and LEDs (Light Emitting Diode) 642 and a phone keypad 644. Application subsystem 602 may also include a loudspeaker 646 and a microphone 648. Additionally, application subsystem 602 may include a baseband processor 650 as well as an RF interface 652 that connects to the baseband processor 650, and a RF upconverter 654. Application subsystem 602 may also include a power supply 656. One of ordinary skill in the art will appreciate that although user terminal 112 of FIG. 6 has been depicted as using specific types of hardware in a specific layout, and other hardware in alternative layouts may be utilized instead.

User terminal 112 may also include applications (not pictured) that are capable of running different services. These services may include telephone services such as an address book, a super pages service, a calendar, a memo pad, and a call log. The services may also include Internet services such as a weather service, a news service, and a sports service. Other services may include a caller ID service, a name display service, a pop up alert service, a mobile alert service, a call forwarding service, a voicemail retrieval service, a real-time call management service, a text messaging service, and a directory service.

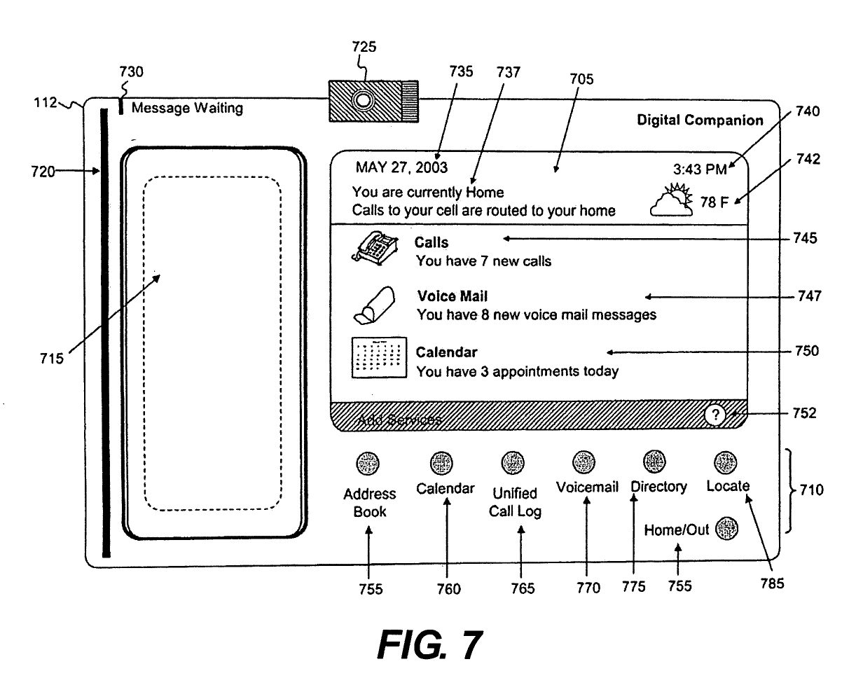

FIG. 7 illustrates exemplary features of a user terminal 112 consistent with the invention. User terminal 112 may include a touch screen or pen-based color LCD display that further includes a graphical user interface 705, multiple action buttons 710, a cordless handset 715 (one of ordinary skill in the art will appreciate that handset 715 could alternatively have a cord), a credit card scanner 720, a video camera 725, and a message-waiting indicator 730. Graphical user interface 705 may include graphical objects that may be selected via the touch screen LCD display (for example, as “soft key” buttons). Such objects, for example, may include a date object 735, a status object 737, a time object 740, a weather object 742, a call log object 745, a voice mail object 747, a calendar object 750 and a help object 752. Date object 735 may indicate a current day and year. Status object 737 may indicate whether a user of user terminal 112 has specified if they are home, or away, and whether the user has forwarded calls, for example, if calls to their cell phone have been forwarded to the “home” user terminal 112. Time object 740 may indicate a current time.

Weather object 742 may indicate a current temperature and, if the weather object is selected via the touch screen LCD display, may further indicate current weather conditions and, possibly, a current weather forecast, in the geographic area where the user terminal 112 is located. Call log object 745 may indicate a number of new calls made to user terminal 112 and, if selected via the touch screen LCD display, may display a unified call log that contains new calls made to the “home” user terminal and to one or more specified cell phones. Voice mail object 747 may indicate a number of new voice mail messages and, if selected via the touch screen LCD display, may display a unified voice mail list that lists new voice mails for the “home” DC phone and for specified cell phones. Calendar object 750 may indicate a number of previously entered appointments for the day indicated in date object 735. If selected via the touch screen LCD display, calendar object 750 may result in the display of a calendar for a current month upon which appointments may be viewed, entered or removed. Help object 752 may, if selected via the touch screen LCD display, lead to a help screen that may explain the various functions and operations of user terminal 112. One of ordinary skill in the art will appreciate that additional objects may be included in a graphical user interface (GUI) 705, for example, GUI 705 may include a call forwarding object that reflects whether or not a call forwarding function is on or off, and enables a user to toggle that function.

Action buttons 710 may include multiple “hard key” buttons that can be selected to initiate various functions. Action buttons 710 may include an address book button 755, a calendar button 760, a unified call log button 765, a voice mail button 770, a directory button 775, a home/out button 780, and a locate button 785. Selection of address book button 755 may result in a display on graphical user interface 705 that permits the viewing, inputting and removal of addresses of individuals or entities, and their corresponding e-mail addresses. Selection of calendar button 760 may result in a display of a calendar for a current month that permits the viewing, inputting and removal of specified appointments on the calendar. Selection of unified call log button 765 may result in a display of a log of new calls made to the “home” user terminal 112 and to specified communication devices that were previously registered with user terminal 112. Selection of voice mail button 770 may result in a display of a list of new voice mails that correspond to the “home” user terminal 112 and to specified communication devices that were previously registered with user terminal 112.

Selection of directory button 775 may result in the display of a telephone directory from which a user of user terminal 112 may determine the telephone and/or address of a specified individual or entity. Selection (e.g., toggling) of home/out button 780 indicates whether the user terminal 112 user is home, and calls to the user's cell phone should be routed to the “home” phone, or whether the user is “out,” and calls to the “home” phone should be routed to another device associated with a user (e.g., a preferred device). Selection (e.g., toggling) of locate button 785 may result in the display of the geographic locations of previously registered communication devices on graphical user interface 705. Such geographic locations may be retrieved from the phone network associated with the registered communication devices.

Handset 715 may include conventional circuitry for processing audio input and output so that a handset user may engage in a conversation. Handset 715 may further include a small LCD display (not shown) that can display various functions performed by the action buttons 710 and/or graphical object user terminal 112. Credit card scanner 720 may accept information from credit cards (or different types of cards) “swiped” through the scanner. Such information may be used for making purchases over a circuit-switched connection via voice network 104 or over a packet-switched connection via data network 102. Video camera 725 may include conventional circuitry for capturing video. Message waiting indicator 730 may indicate when voice mail messages corresponding to the “home” user terminal, or registered communications devices, are available to be retrieved via user terminal 112.

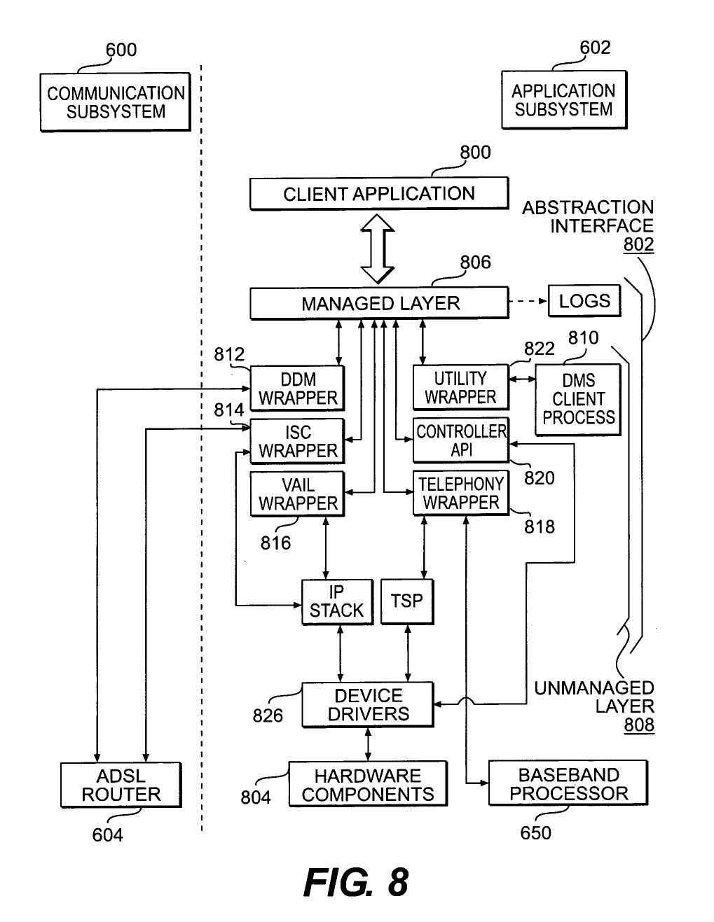

FIG. 8 illustrates a view of software components in accordance with one embodiment consistent with the present invention. A client application 800 may provide a user interface for user terminal 112. An abstraction interface 802 may provide a unified framework for client application 800 to permit user access to the functionality of various hardware components 804 within user terminal 112. More specifically, abstraction interface 802 may provide an abstraction layer interfacing client application 800 to firmware, e.g., device drivers 826 and processors, such as ADSL Bridge Router 604, processor 632 and baseband processor 650. Hence, any changes in the hardware chipsets, drivers and the controllers will have a minimal impact on hardware component interfaces to a client application, such as client application 800.

In order to permit user access to the functionality of various hardware components 804, abstraction interface 802 may provide a direct conversion between a lower layer and an upper layer of Open System Interconnection (OSI) model layers. OSI model guidelines allow for seven layers of protocol conversion between users and physical hardware. Abstraction interface 802 may, for example, directly convert data link layer protocols (corresponding to OSI layer two), on the one hand, and session layer protocols, presentation layer protocols, and application layer protocols, on the other hand (corresponding to OSI layers five, six, and seven, respectively), without any intermediate layer protocols, such as network layer and transport layer protocols (corresponding to OSI layers three and four, respectively). Because client application 800 may use only application layer protocols for certain communications, intermediate layer protocols omitted by abstraction interface 802 may also include session layer and presentation layer protocols.

Client application 800 and abstraction interface 802 may run on processor 632 and may interact with an operating system (not shown), such as Win CE.NET (from Microsoft Corporation, Redmond, Wash.) running on processor 632. A Win CE.NET operating system may include a Common Language Runtime (CLR) framework, which permits communication and tightly integrated behavior among software written in different languages. “Managed code” or “managed layers” may include software designed to run inside a runtime framework, such as a Win CE.NET CLR. “Unmanaged code” or “unmanaged layers” may include software that is designed to run outside the Win CE.NET CLR.

Client application 800 may be a managed .NET application and may output data using session layer protocols, presentation layer protocols, or application layer protocols. Client application 800 may include input interface 208 and output interface 210. As explained above in reference to FIG. 2, input interface 208 may receive input from user 110 via input device 212 and provides the input to a processor such as CPU 200 or processor 632. Input device 212 may include, for example, a keyboard (or individual buttons), a microphone, a camera, graphical user interface, and/or a mouse. Output interface 210 may provide information to user 110 via output device 214. Output device 214 may include, for example, a display, (including a touchscreen or pen-based LCD display, or other type of display), a printer, and/or a speaker. Client application 800 may change the flow of control from user terminal 112 to client application 800 or vice versa. For example, when a user makes an outgoing call, client application 800 may notify abstraction interface 802 as to whether a POTS call or a VoIP call is to be made, in accordance with predetermined criteria. Abstraction interface 802 may then call the appropriate software for initiating and/or carrying out an action corresponding to this call.

Hardware components 804 may include: baseband processor 650, processor 632, ADSL Bridge Router 604, a cordless telephone base station, cordless handsets with intercom facility, phone keypad, speaker 646, microphone 648, a camera, a DSL modem, a WIFI router, Ethernet hub 627, PSTN lines, VoIP lines, buttons and LEDs, including, for example, a flash button, a redial button, an intercom button, a volume up button, a volume down button, a mute button, a hold button, a speaker button, a calendar application button, an address application button, a reset button, a power LED, a DSL LED, an Ethernet LED, a Wireless LED, an Internet LED, an In-use LED, a voicemail LED.

Baseband processor 650 may control RF interface 652 and RF upconverter 654 to provide user access to voice network 104. Baseband processor 650 may also control jack (Fax/Modem) 612 to provide user access to a fax/modem service. An operating system, such as Linux, may run on baseband processor 650 in order to facilitate control of voice and fax/modem services.

ADSL Bridge Router 604 may include a processor to provide user access to data network 102 including various data related services such as ADSL services, wireless network services, and VoIP services. An operating system, such as VxWorks (from Wind River Systems, Inc., Alameda, Calif.), may run on the processor included in ADSL Bridge Router 604 in order to facilitate control of the various data related services.

Abstraction interface 802 may include a managed layer 806 and an unmanaged layer 808. Abstraction interface 802 may provide functionality for user terminal 112 to notify client application 800 about any changes occurring on user terminal 112, maintain a current device state for various hardware and logical devices in the system for client application 800 to access, notify client application 800 of any device error condition and device exceptions, and implement logging for any device error conditions.

Abstraction interface 802 may also accept method calls from client application 800 for any state changes to be made on user terminal 112. A state change may occur when, for example, a PSTN line is activated or any user-interface buttons are pressed. Abstraction interface 802 may in turn provide notifications (e.g., raise events) to client application 800 for any changes or notifications coming from hard key buttons 710 of user terminal 112 or any hardware in user terminal 112. Abstraction interface 802 may also maintain a current state for individual hardware components in user terminal 112 and may serve as a representative of an actual hardware state.

Managed layer 806 of abstraction interface 802 may be, for example, a .NET library within the Win CE.NET operating system. Managed layer 806 may include multiple software interfaces, for example, C# interfaces. The multiple software interfaces may enable client application 800 to make method calls to abstraction interface 802. Client application 800 may make method calls for making action calls (e.g., going off-hook), getting/setting device properties, and setting states of client application 800. Managed layer 806 may use an event manager (not shown) to post or raise events on client application 800. Events may be raised for any hardware component events, setting/state changes, and for any error/exception conditions. Managed layer 806 interactions may be done inside a managed NET Compact framework. Other modes of interfacing between client application 800 and abstraction interface 802 may also exist.

Unmanaged layer 808 may include a Device Management System (DMS) client process 810, a layer of software wrappers 812-822 (including, for example, a DSL Data Manager (DDM) wrapper 812, an Inter-System Connect (ISC) wrapper 814, a VoIP Application Interface Layer (VAIL) wrapper 816, a Telephony wrapper 818, a Controller Application Program Interface (API) wrapper 820, and a Utility wrapper 822), and various other software objects and processes.

Wrappers 812-822 may provide access between managed layer 806 of abstraction interface 802 and hardware components 804 residing in both application subsystem 602 and communication subsystem 600. Wrappers 812-822 may be embedded C/C++ libraries, residing in memory accessible to processor 632 of user terminal 112, and may encapsulate different device management APIs for device drivers 826 associated with hardware components 804. Wrappers 812-822 may be developed by vendors according to predetermined interface standards in order to update or add functionality to user terminal 112. Thus, wrappers 812-822 may be for example, in unmanaged code and based on custom and Win32 APIs. Wrappers 812-822 may translate or reformat method calls from managed layer 806 to an appropriate format, such as Platform Invoke (Plnvoke) method calls to be received by device drivers 826. Wrappers 812-822 may use Plnvoke and Message Window functionality for providing notifications received from device drivers 826 to update client application 800 via managed layer 806.

DMS client process 810 may be an independent Win CE process written in unmanaged code. Abstraction interface 802 may communicate with DMS client process 810 through unmanaged utility wrapper 822, to provide device state information and also for the DMS client to query the state of client application 800. Utility wrapper 822 may use memory mapped objects and events to communicate with DMS client process 810.

DDM wrapper 812 may include an XML over Hypertext Transfer Protocol (HTTP) interface provided for abstraction interface 802 to access ISC hardware and logical components including, for example, components in communication subsystem 600. Components supported by DDM wrapper 812 may include a DSL modem, a wireless router, Ethernet hub 627, firewall, internal LAN (wireless), and ISC state. DDM wrapper 812 may also access ADSL Bridge Router 604 through XML over HTTP protocol. The XML format may include get/set calls. Abstraction interface 802 may extract information returned from DDM wrapper 812 to set its states. For event notification from communication subsystem 600, ISC wrapper 814 may be used.

ISC wrapper 814 may provide an interface to hardware and logical components associated with communication subsystem 600 through a custom Windows CE process. Hardware and logical components supported may include DSL modem, wireless router, Ethernet hub, firewall, internal LAN (wireless), ISC state, network. ISC wrapper 814 may be based on custom and Win-32 APIs. ISC wrapper 814 may further include other hardware related modules spread across multiple DLL libraries which talk to the respective device drivers in both application subsystem 602 and communication subsystem 600.

Telephony wrapper 818 may provide an interface to all the telephony related devices in application subsystem 600. Hardware components supported may include baseband processor 650, a cordless handset, PSTN line(s), VoIP line(s), speaker 646, microphone 648, and telephony related buttons on user terminal 112. Telephony wrapper 818 may be based on vendor specific custom Telephony Application Programming Interface (TAPI) implementations. Telephony wrapper 818 may further include other hardware related modules spread across multiple DLL libraries which may talk to respective device drivers.

Controller API wrapper 820 may interface with additional hardware components in application subsystem 602 not related or supported by Telephony wrapper 818. These hardware components may include, LCD Screen, LEDs, various buttons (soft reset, for example). Controller API wrapper 820 may be based on custom and Win32 APIs. Controller API wrapper 820 may further include other hardware related and custom software modules spread across multiple DLL libraries.

Interactions between client application 800 and abstraction interface 802 may be through method calls from client application 800 and abstraction interface 802. Interactions between abstraction interface 802 and underlying hardware components 804 may be done through Plnvoke method calls. Table 1 below includes examples of process flows and describes how they may be handled.

TABLE 1
Typical Application Process Flows

| Action | Origin | Destination | Mode | Functionality |
|---|---|---|---|---|
| User Action (User | Client | Abstraction | Method Call | Client Application calls a |
| Interface Soft Key | Application | Interface | | method on Abstraction |
| Button Press) | | | | Interface, which in turn calls |
| | | | | the respective hardware |
| | | | | functionality |
| Device Action | Abstraction | Client | RaiseEvent( ) | Client Application registers, |
| (Hard Key Button | Interface | Application | | receives the notification and |
| Press) | | | | calls respective Client |
| | | | | Application functionality |
| Device Status | Client | Abstraction | Method Call | Abstraction Interface responds |
| request | Application | Interface | | with the current device status |
| Device functionality | Client | Abstraction | Method Call | Abstraction Interface calls the |
| request | Application | Interface | | respective unmanaged |
| | | | | wrapper to provide the service. |
| Setting Client State | Client | Abstraction | Method Call | Abstraction Interface sets its |
| | Application | Interface | | state and informs listeners like |
| | | | | DMS client. |
| Exception/Error | Abstraction | Client | RaiseEvent( ) | Abstraction Interface throws an |
| conditions | Interface | Application | | error or exception notification |
| | | | | to CA for the respective Error |
| | | | | or Exception condition based |
| | | | | on its severity. |
| Logging | Abstraction | Client | RaiseEvent( ), | Abstraction Interface raises an |
| | Interface | Application, | Method Call | error event and logs it to file. |
| | | Abstraction | | |
| | | Interface | | |

In summary, abstraction interface 802 may provide a unified framework for client application 800 to permit user access to the functionality of various hardware components 804 and processors (e.g., ADSL Bridge Router 604 and baseband processor 650) within user terminal 112. In doing so, abstraction interface 802 may provide a direct protocol conversion between upper OSI model layers and lower OSI model layers. Hence, processors, drivers, and controllers may be replaced and added with minimal impact on hardware component interfaces to client application 800.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

1. An integrated communications device including hardware components, the device comprising:
a first processor configured to control a first hardware component function;
a second processor configured to run an abstraction interface and a client application, the client application providing a user interface;
wherein the abstraction interface is adapted to make a direct conversion between protocols used by the first processor and protocols used by the client application to permit control of the first hardware component function via the client application.

2. The integrated communications device of claim 1, wherein the first hardware component is a component configured to provide access to at least one of a data communications network and a voice communications network.

3. The method of claim 2, wherein the data communications network is adapted to provide at least one of a digital subscriber line service, a wireless network service, a fax service, and a voice over internet protocol service.

4. The integrated communications device of claim 1, wherein the first processor is adapted to run a first operating system and the second processor is adapted to run a second operating system distinct from the first operating system.

5. The integrated communications device of claim 1, wherein the abstraction interface includes an unmanaged layer and a managed layer, the managed layer being adapted to run inside a runtime framework and the unmanaged layer being adapted to run outside the runtime framework.

6. The integrated communications device of claim 5, wherein the unmanaged layer includes a first software wrapper configured to interface with the first processor.

7. The integrated communications device of claim 5, further comprising a device driver associated with a second hardware component, wherein the unmanaged layer includes a second software wrapper configured to interface with the device driver.

8. The integrated communications device of claim 1, wherein the client application is adapted to use application layer protocols and the first processor is adapted to use data link layer protocols.

9. The integrated communications device of claim 1, wherein the abstraction interface is adapted to receive method calls from the client application to control the first hardware component function.

10. The integrated communications device of claim 1, further comprising a device driver associated with a second hardware component, wherein the abstraction interface is further adapted to receive event notifications from the device driver to update the client application.

11. The integrated communications device of claim 1, wherein the abstraction interface is adapted to:
maintain a current state associated with a hardware component; and
notify the client application of changes in the current state of the hardware component.

12. The device of claim 1, wherein the abstraction interface is adapted to:
notify the client application of an error condition in the device; and
log the error condition.

13. A method comprising:
receiving messages produced by a client application executing in an integrated communications device associated with a user;
directly converting the messages produced by the client application to protocols used by a first processor in the integrated communications device to provide user access to a communications service provided by a first hardware component operatively connected to the first processor;
receiving messages produced by the first processor;
directly converting the messages produced by the first processor to protocols used by the client application to provide user control of the communications service provided by the first hardware component operatively connected to the first processor,
wherein the client application is adapted to run on a second processor.

14. A computer-readable medium storing instructions executable to perform the method of claim 13, wherein the instructions are executable by the second processor.

15. The method of claim 13, wherein the first hardware component is a component for providing user access to at least one of a data communications network and a voice communications network.

16. The method of claim 15, wherein the data communications network provides at least one of a digital subscriber line service, a wireless network service, a fax service, and a voice over internet protocol service.

17. The method of claim 13, wherein the first processor is executing a first operating system and the second processor is executing a second operating system distinct from the first operating system.

18. The method of claim 13, wherein directly converting the messages produced by the client application includes reformatting messages formatted in accordance with application layer protocols into messages formatted in accordance with at least one of a hypertext protocol and a telephony programming interface protocol.

19. The method of claim 13, wherein the messages produced by the client application are received via application layer protocols and the first processor is adapted to use data link layer protocols.

20. An integrated communications device comprising:
an application subsystem including a first processor to run a client application to interface with user input and output devices;
a communication subsystem operatively connected to the application subsystem and including a second processor to control data and voice communication devices; and
an abstraction interface adapted to run on the first processor and to make a direct conversion between protocols used by the second processor and protocols used by the client application to permit control of the data and voice communication devices via the client application,
wherein the abstraction interface includes an unmanaged layer and a managed layer, the managed layer being adapted to run inside a runtime framework and the unmanaged layer being adapted to run outside the runtime framework, and
wherein the data communication devices are adapted to provide access to a data network.
